(19) United States
(12) Patent Application Publication
(10) Pub. No.: US 2009/0112773 A1
(43) Pub. Date: Apr. 30, 2009

(54) Automated Private Financing Network

(76) Inventors: Yuh-Shen Song, Northridge, CA (US); Catherine Lew, Northridge, CA (US); Alexander Song, Northridge, CA (US); Victoria Song, Northridge, CA (US)

Correspondence Address: FULBRIGHT AND JAWORSKI LLP, 555 S. FLOWER STREET, 41ST FLOOR, LOS ANGELES, CA, 90071, US

(21) Appl. No.: 12/125,752

(22) Filed: May 22, 2008

Related U.S. Application Data
(60) Provisional application No. 61/000,821, filed on Oct. 30, 2007.

(51) Int. Cl. G06Q 40/00

(52) U.S. Cl. 705/36 R; 705/37

(57) ABSTRACT

A computerized and networked system and method empower individuals and businesses to obtain private financing from qualified investors by offering risk diversification and investment liquidity. In addition, progress of the individuals and businesses is monitored to ensure their compliance with the business plans submitted to the investors. Furthermore, suspicious activities are monitored, detected and reported in accordance with the anti-money laundering, anti-terrorist financing and/or anti-financial crimes regulatory requirements.

### CROSS REFERENCE TO RELATED APPLICATION

This application claims the benefit of U.S. provisional application No. 61/000,821 filed on Oct. 30, 2007, the disclosure of which is expressly incorporated by reference herein in its entirety.

### FIELD OF DISCLOSURE

The present disclosure relates generally to computer networking systems. More specifically, the present disclosure uses computer networks and modern technologies to help individuals and businesses obtain private financing from qualified investors.

### BACKGROUND

Publicly-listed companies usually can obtain their needed financial resources through public financing, e.g., stock market, bond market and many other options. In comparison, privately-held businesses have very limited choices when they need financial resources.

For “small” privately-held businesses, obtaining the necessary financing is extremely difficult, especially when they are not profitable yet. Although venture capitalists exist, the chance for a small privately-held company to receive venture capital investment is extremely low.

Most individuals and privately-held business owners have to obtain financial support from relatives and friends. Since their relatives and friends may only have limited financial resources, many great ideas, projects, products, companies, assets, etc. have to be abandoned because individuals or business owners run out of money.

To protect the general public, most governments have established very strict rules, which prohibit individuals and privately-held businesses from soliciting the general public with equity or debt investment opportunities. For example, an individual or a privately-held company in the United States can only sell equity or debt investments to those qualified investors whose annual income and assets have met the minimum requirements set by the government. These minimum requirements are so high that only 1% of the population may meet these requirements.

Although these qualified investors exist, most individuals and owners of privately-held businesses do not know where to find these qualified investors and how to effectively secure financing from them. In the past, finding the needed financial resources has been a major obstacle to individuals and privately-held businesses.

Qualified investors also have their own concerns. For example, most qualified investors want to diversify their investment risks. An investor typically prefers spreading his/her investments into many different projects, products, organizations, assets, etc. so that, if something goes wrong in any particular project, product, organization, asset, etc., he/she will not be significantly affected.

As a result of this diversification principle practiced by qualified investors, an individual or a business owner may need to reach many qualified investors in order to meet his/her financing need. For an entrepreneur who starts up a new company or a business owner of a small privately-held company, the most commonly-used approach to raise money is selling the equity of the company to qualified investors.

However, many government regulations restrict the total number of shareholders in a privately-held company. If the number of shareholders exceeds a number established by its local government, the company may incur tremendous overhead in order to comply with laws, regulations and rules as if it is a public company.

For example, the recent Sarbanes Oxley Act in the USA has placed so much overhead on public companies that some public companies have actually gone private to avoid this overhead by selling their companies to private equity firms. For a startup company or a small privately-held business, such overhead will obstruct its productivity, increase its operational cost, and may ruin the company. Therefore, a startup company or a small privately-held business desires to have as few shareholders as possible to avoid the laws, regulations and rules applied to public companies.

Even if the total number of shareholders has not reached the regulatory limit for a privately-held company, it is desirable for a privately-held business to have as few shareholders as possible to reduce the overhead of dealing with many different shareholders.

To limit the number of shareholders, entrepreneurs and privately-held business owners may have to set a minimum investment amount from each qualified investor so that they can achieve their financing targets without having too many shareholders. However, such a minimum investment amount limit practically conflicts with the interest of qualified investors who intend to diversify their investments.

In addition, investors are also concerned about the liquidity of their equity investment into startup or privately-held companies. Many governments have laws, regulations and rules which restrict the security trading of privately-held companies. Investors have to hold the equity investment of a startup company or a privately-held company indefinitely until the company is acquired by another business or becomes public.

Potentially, investors may be stuck with their equity investments in startup companies or privately-held companies for many years without any return on investment. This situation represents a great deal of risk to the investors. If the business went sour during this long period of waiting time, investors might lose their entire investment in the business.

In addition, investors are also concerned with whether the individuals and businesses which they have invested into are using the money according to their business plan. For example, a liar can write a very good business plan, obtain the money from investors then lose all the money in a casino.

Therefore, providing private financing to individuals and privately-held businesses represents a huge risk to investors.

Due to all the concerns and conflicts listed above, it has been extremely difficult for individuals or privately-held businesses to obtain financing and consequently, many great ideas, projects, products, companies, assets, etc. have to be abandoned due to lack of financial resources.

Even public-listed companies may need private financing from time to time. Although public-listed companies may represent less risk to investors, such financing is not free of any risk. Investors of private financing need the same type of protection regardless of whether they are investing in privately-held or public-listed businesses.

If an organization facilitates financial transactions between individuals, businesses and investors, such an organization will be classified as a financial institution. After the 9/11 tragedy, most governments have established laws, regulations and rules which require financial institutions to detect and report transactions that are potentially involved with money laundering or terrorist financing activities. Many financial institutions in the USA have already paid hundreds of millions of dollars in penalties because they failed to enforce their anti-money laundering and anti-terrorist financing programs as required by the United States government. These anti-money laundering and anti-terrorist financing requirements have created huge overhead and burden to the organizations which facilitate private financing transactions and thus further aggravate the difficulties for individuals and businesses to obtain private financing.

### SUMMARY

In this document, a “bank” or “financial institution” is generally referred to as a financial service provider, either a bank or a non-bank, where financial services are provided.

In this document, a “bank account” or “financial account” is generally referred to as an account in a financial institution, either a bank or a non-bank, where financial transactions are conducted through payment instruments such as cash, checks, credit cards, debit cards, electronic fund transfers, etc.

In this document, a “business plan” is generally referred to as a plan with some types of financial arrangements to reach certain goals. For example, an entrepreneur may have a business plan to start a company. A company may have a business plan to expand its market share. An individual may have a business plan to purchase a house. A student may have a business plan to study for his/her Ph.D. Degree. A private equity firm may have a business plan to unload its investments.

In this document, “securities” are generally referred to according to the definition in the Securities Act of 1933. For example, securities may generally include note, stock certificate, bond, debenture, check, draft, warrant, traveler's check, letter of credit, warehouse receipt, negotiable bill of lading, evidence of indebtedness, certificate of interest or participation in any profit-sharing agreement, collateral-trust certificate, preorganization certificate or subscription, transferable share, investment contract, voting-trust certificate; valid or blank motor vehicle title; certificate of interest in property, tangible or intangible; instrument or document or writing evidencing ownership of goods, wares, and merchandise, or transferring or assigning any right, title, or interest in or to goods, wares, and merchandise; or, in general, any instrument commonly known as a “security”, or any certificate of interest or participation in, temporary or interim certificate for, receipt for, warrant, or right to subscribe to or purchase any of the foregoing.

In this document, “subjects” generally include businesses, organizations, business plans, agreements, projects, products, goods, services, commodities, energy, mines, metals, chemical elements, weapons, vehicles, materials, wares, merchandises, collections, inventory, receivables, collaterals, jewelries, arts, crafts, valuables, securities, futures, rights, interests, titles, money, funds, financial instruments, real estates, objects, properties and/or assets.

Although we use the equity financing of a privately-held company as a primary example in this document, the present invention also applies to any type of financing of any individual, any private or public, profit or non-profit organization, any private or public subjects.

One objective of the present invention is to automate global private financing activities through networked computers. Another objective is to overcome the obstacles placed by laws, regulations and rules regarding private financing and, at the same time, provide investors with their desired protections. Another objective is to fulfill the anti-money laundering, anti-terrorist financing, and anti-financial crimes requirements imposed by governments worldwide.

To reach all these goals, an online club is established on a computer network. Qualified investors can join the club through the computer network. For easy reference, we will refer to this club as Qualified Investors Club in this document. The Qualified Investors Club can screen the background of its members to ensure that (1) they have met or exceeded the minimum requirements set by governments worldwide and (2) they are not on a blacklist published by various government authorities for anti-money laundering, anti-terrorist financing and anti-financial crimes purposes.

In addition, an online website is established so that individuals and businesses can submit their business plans and apply for private financing through the computer network. For easy reference, we will refer to this website as Private Financing Center in this document.

The Qualified Investors Club can conduct due diligence on the individuals, the businesses, and their business plans. In addition, the Qualified Investors Club can ensure that these individuals and businesses are not on blacklists published by various government authorities for anti-money laundering, anti-terrorist financing and anti-financial crimes purposes.

Once a business plan is accepted by the Qualified Investors Club and a commercial arrangement is agreed upon, such a business plan will be posted online. Online posting enables members of the Qualified Investors Club to review the business plan, conduct online discussions, interview the individuals or business representatives, and inform the Qualified Investors Club of their respective monetary commitments to the business plan.

If the total commitment from all interested members reaches a financing target set in the business plan, the Qualified Investors Club will collect funds from the members who have made commitments and then establish a special fund with all the committed members as “sponsors” of the special fund. For easy reference in this document, we will refer to this special fund as “Angel Fund”.

For easy reference in this document, a sponsorship can be described in terms of a number of sponsorship units. For example, if an Angel Fund consists of $1,000,000, the Qualified Investors Club can define that a total of 1,000,000 sponsorship units are issued by the Qualified Investors Club for the Angel Fund and each sponsorship unit has an initial value of $1 at the time of issuance. If a sponsor has committed $10,000 in the Angel Fund, he/she will receive 10,000 sponsorship units at $1 each.

The Qualified Investors Club will use the Angel Fund to acquire an amount of equity or debt participation from the individuals or businesses based on their business plan. Since the Qualified Investors Club will only be “one” counterparty in the transaction with a privately-held business, there is no need for a privately-held business to worry about interacting with too many investors or to worry about complying with laws, regulations and rules regarding raising money from many investors. For example, if a privately-held company is raising capital through equity financing, it will only add one shareholder, the Qualified Investors Club, into the company after completing the financing.

Since there are many members in the Qualified Investors Club, an Angel Fund can be sponsored by many qualified investors with different amounts of monetary commitment. Such flexibility is important because different investors may have different preferences in taking risks.

Since each committed member is only a sponsor of the Angel Fund, but not a shareholder of the company, he/she is free to transfer his/her sponsorship units to other members of the Qualified Investors Club in a private transaction. As a result of such private transactions, qualified investors have the liquidity they need in the investment.

Since there will be many Angel Funds in the Qualified Investors Club, a member can easily reach his/her goal of risk diversification through sponsoring many different Angel Funds.

To facilitate the private transactions among members, the Qualified Investors Club can post the intention of transferring the sponsorship units by any sponsor of any Angel Fund, his/her “asking pricing for the sponsorship unit” and “the number of sponsorship units” that are available for transfer. The Qualified Investors Club can provide members with the reference information, including the original business plan of the Angel Fund, the current progress of the business plan, the reports by the individuals or businesses, the financial figures and auditing results of the businesses, the discussions among qualified investors regarding the individuals or businesses, etc. Similarly, a member can offer his/her “bidding price for the sponsorship unit” for a particular Angel Fund and “the number of sponsorship units” that he/she is interested in sponsoring. All these transactions can be completed electronically by a computer of the Qualified Investors Club.

Alternatively (or in addition), the Qualified Investors Club can provide online communication facilities such as online social networks, chat rooms, etc. so that members of the Qualified Investors Club can communicate among one another to complete their transfers of sponsorship units in a private manner.

Although the sponsorship units of the Angel Fund have been transferred between members, there is no change of ownership in the equity or debt participation, which is the Qualified Investors Club. As a result, these private transactions among members are totally transparent to the privately-held company. Thus, there is no need for the privately-held company to exert extra effort to comply with the complicated laws, regulations and rules related to ownership change in a privately-held company.

If the privately-held company issues dividends, the dividends will be passed on to the then-current sponsors of the Angel Fund according to their percentage sponsorship of the Angel Fund. For easy reference in this document, the “percentage sponsorship” of a sponsor is defined as the ratio of “the number of sponsorship units owned by a sponsor of an Angel Fund” to “the total number of sponsorship units of the Angel Fund.” For example, if a sponsor is sponsoring 20% of the Angel Fund and the business has issued a dividend of $100,000 to the Qualified Investors Club which is the shareholder, such a sponsor will receive $20,000 as a result of his/her sponsorship of the Angel Fund.

If the privately-held company is acquired by another company, the Qualified Investors Club will distribute the proceeds of the sales to the then-current sponsors of the Angel Fund according to their percentage sponsorship of the Angel Fund. If the privately-held company goes public, the equity ownership of the Qualified Investors Club will be passed on to the then-current sponsors of the Angel Fund according to their percentage sponsorship of the Angel Fund. The sponsors can sell the equity in the public market to realize their return on investment.

Since the sponsorship units of the Angel Fund can be transferred among the qualified investors, the transfer price becomes a good indicator of the market value of the business. Therefore, it is also possible for the individuals and businesses to raise additional funds from the Qualified Investors Club based on the transfer price of the sponsorship units of the Angel Fund.

Moreover, since all the transactions, background of the individuals, businesses, and investors are recorded by the computer of the Qualified Investors Club, suspicious activities can be detected and reported to the government agencies in compliance with anti-money laundering, anti-terrorist financing and anti-financial crimes laws, regulations and rules.

To protect the investors, the Qualified Investors Club can electronically monitor the individuals and businesses, which have received financing from the Qualified Investors Club. The financial data, auditing results, and activities are collected through networks and recorded by the Qualified Investors Club so that sponsors of the Angel Fund can review this operational information in real time. Furthermore, money can be released to the individuals and businesses in steps when they reach milestones according to the business plan. As a result of these provisions, the investors are protected against possible dishonest practices by individuals and businesses which have received financing from the Qualified Investors Club.

The foregoing has outlined rather broadly the features and technical advantages of the present disclosure in order that the detailed description that follows may be better understood. Additional features and advantages will be described hereinafter which form the subject of the claims. It should be appreciated by those skilled in the art that the conception and specific embodiments disclosed may be readily utilized as a basis for modifying or designing other structures for carrying out the same purposes of the present disclosure. It should also be realized by those skilled in the art that such equivalent constructions do not depart from the spirit and scope of the invention as set forth in the appended claims. The novel features which are believed to be characteristic of the disclosure, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

### BRIEF DESCRIPTION OF THE FIGURES

For a more complete understanding of the present disclosure, reference is now made to the following descriptions taken in conjunction with the accompanying drawing.

FIG. 1 is a network diagram of an Automated Private Financing Network (“APFN”).

FIG. 2 (comprising FIG. 2A, FIG. 2B, and FIG. 2C) is a set of flow charts of an example, indicating how the networked system shown in FIG. 1 completes the process of obtaining financing for a privately-held company.

FIG. 3 (comprising FIG. 3A, FIG. 3B and FIG. 3C) is a set of flow charts of an example, indicating how the networked system shown in FIG. 1 provides liquidity protection to qualified investors.

FIG. 4 is a flow chart of an example, indicating how the networked system shown in FIG. 1 may reward investors when a privately-held company goes public.

### DETAILED DESCRIPTION

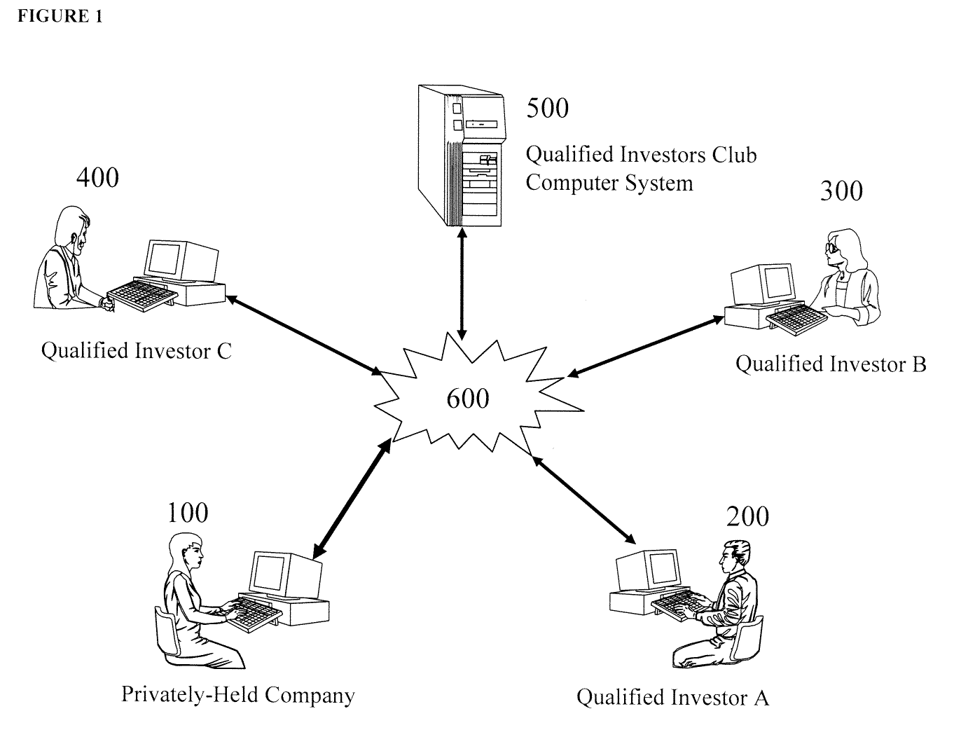

Referring to FIG. 1, an Automated Private Financing Network (“APFN”) is established on a computer network, which can be accessed by many qualified investors such as 200, 300, 400. A networked computer system 500 of APFN records the transactions, controls the mechanism, and manages the activities occurring on the APFN. In this example, “qualified investors 200, 300, 400” are generally used to represent a group of qualified investors, instead of 3 investors. In practice, there may be any number of qualified investors in the Qualified Investors Club.

In one embodiment of the present invention, when an investor 200, 300, or 400 is interested in joining the Qualified Investors Club, he/she fills in his/her background, his/her personal identification information including nationality, etc., his/her particular interest and scope of investment, and his/her qualification information online through a user interface of the networked computer system 500 in order to apply for a membership of the Qualified Investors Club. The networked computer system 500 stores this information into a database. In one embodiment of the present invention, this information provided by a member can also be used by the networked computer system 500 to search for potential investment opportunities for this particular member. For example, if a member 200, 300 or 400 indicates that he/she is more interested in biotechnology investment, the networked computer 500 will electronically inform the member through the network 600 when a biotechnology investment opportunity is available.

The Qualified Investors Club will conduct due diligence of the applicant to ensure that he/she is a qualified investor based on laws, regulations and rules established by different governments worldwide. Through this due diligence provision, the Qualified Investors Club can ensure that its members can legally participate in a particular investment activity without violating any law, regulation, or rule which may govern that particular investment. In one embodiment of the present invention, an applicant of the Qualified Investors Club answers a series of questions online through a user interface of the networked computer system 500. Knowledge of due diligence is incorporated into the networked computer system 500 so that the networked computer system 500 can electronically conduct the due diligence process and enforce regulatory compliance based on the answers provided by the applicant.

To comply with laws and regulations in some countries, in one embodiment of the present invention, the Qualified Investors Club can be set up as a corporation and each member becomes a shareholder of the corporation. In another embodiment of the present invention, the Qualified Investors Club can be set up as a partnership and each member becomes a partner. In yet another embodiment of the present invention, the Qualified Investors Club can be set up as a legal entity and each member is given the proper right in the legal entity to reach the goals of the present invention.

When an individual or a business 100 intends to obtain financing from the Qualified Investors Club, in one embodiment of the present invention, the individual or business 100 fills in his/her/its background information, his/her/its identification information, nature and scope of the business plan, and target investment amount online through a user interface of the networked computer system 500, submit his/her/its business plan to the Qualified Investors Club, and applies for approval from the Qualified Investors Club. The networked computer system 500 stores the information into a database. In one embodiment of the present invention, the information provided by the individual or business 100 can be used to match the business plan with the interest of members 200, 300, 400 of the Qualified Investor Club. For example, if a business is raising money for a real estate development project, the networked computer system 500 can identity which members have expressed interest in such type of project and electronically inform these members of this opportunity through the network 600.

The Qualified Investors Club will conduct due diligence on the applicant 100 and the business plan to ensure that the business plan is feasible and acceptable to the Qualified Investors Club and such investment is legitimate based on the applicable laws, regulations and rules. In one embodiment of the present invention, the individual or business 100 answers a series of questions regarding the business plan online through a user interface of the networked computer system 500. Knowledge of due diligence is incorporated into the networked computer system 500 so that the networked computer system 500 can electronically conduct the due diligence process and enforce regulatory compliance based on the answers provided by the individual and business.

Through these due diligence provisions on the members, applicants and the business plans, the Qualified Investors Club can ensure that its members can legally participate in a particular investment activity without violating any law, regulation, or rule which may govern that particular investment.

To protect its members, in one embodiment of the present invention, the Qualified Investors Club may need to have an agreement with the individual or business, who needs financing from the Qualified Investors Club, to restrict future (1) issuance of equity or debt, (2) mergers and acquisitions, (3) transfer of assets, (4) transactions with affiliates, (5) dissolution of the company, (6) unreasonable salary raises and bonuses, (7) unreasonable expenses, or (8) other activities that may alter the fundamental value of the investment by the Qualified Investors Club.

Furthermore, in another embodiment of the present invention, the Qualified Investors Club may want to have some controls over the Board resolutions, raise of capital, use of capital, accounting and auditing, insurance and other matters to ensure that the individual or business will comply with the business plan that is approved by the Qualified Investors Club. As one alternative embodiment of the present invention, the above agreement and control conditions can be posted online through a user interface of the networked computer system 500 and the applicant 100 can electronically accept such an agreement and control conditions.

In yet another embodiment of the present invention, the Qualified Investors Club may monitor the individuals and businesses 100 electronically. Financial data, auditing results, activities, etc. are collected in multimedia formats and recorded in a database of the networked computer system 500. Members can review this operational information from time to time through a user interface of the networked computer system 500.

In one embodiment of the present invention, once the individual or business 100 has passed the due diligence process, the business plan has been approved by the Qualified Investors Club and an arrangement has been agreed upon between the Qualified Investors Club and the individual or business, the business plan and the background of the individual or business 100 will be posted online. Members 200, 300, 400 of the Qualified Investors Club can then have access to such information online through a user interface of the networked computer system 500.

In another embodiment of the present invention, members 200, 300, 400 of the Qualified Investors Club can conduct online conferences with the individual or business 100 through the network 600 to further understand the business plan and to better know the individual or the business 100. In yet another embodiment of the present invention, the Qualified Investors Club can host a meeting so that members 200, 300, 400 of the Qualified Investors Club can meet the individual or representatives of the business 100 in person.

In one embodiment of the present invention, after the members 200, 300, 400 of the Qualified Investors Club have completed their evaluation processes, the Qualified Investors Club will ask its interested members 200, 300, and/or 400 to make monetary commitments.

In one embodiment of the present invention, if the total amount of the monetary commitments from all interested members 200, 300, and/or 400 has not met the fund-raising target of the business plan, the Qualified Investors Club will continue to promote this investment opportunity to its members 200, 300, 400 online through the network 600. Alternatively, in another embodiment of the present invention, the Qualified Investors Club can renegotiate with the individual or the business 100 to make the investment opportunity more attractive to its members 200, 300, 400.

If the total amount of the monetary commitments from all interested members such as 200, 300, and/or 400 has met the fund-raising target of the business plan, the Qualified Investors Club will collect money from the committed members to establish a special Angel Fund for this particular business plan and record the Angel Fund into a database of the networked computer system 500. Each committed member is recorded as a sponsor of the Angel Fund in a database of the networked computer system 500 maintained by the Qualified Investors Club. The amount of sponsorship units of each sponsor is also recorded in the same database of the networked computer system 500.

To comply with laws and regulations in some countries, in one embodiment of the present invention, each of the Angel Funds can be established as a corporation. A sponsor of the Angel Fund becomes a shareholder of the corporation. Alternatively, in another embodiment of the present invention, each of the Angel Funds can be established as a partnership. A sponsor of the Angel Fund becomes a partner of the partnership. In yet another embodiment of the present invention, each of the Angel Funds can be established as a legal entity. A sponsor of the Angel Fund is given proper right to reach the goals of the present invention.

The Qualified Investors Club will use the Angel Fund to purchase equity, debt, derivative or other types of participation in the subjects according to the business plan. Through this approach, since the Qualified Investors Club is the owner of the participation, the individual or business 100 which has received the financing from the Qualified Investors Club only needs to do business with the Qualified Investors Club. The individual or business does not have to transact business with the sponsors of the Angel Fund. As a result, the individual and business 100 can avoid tremendous overhead placed by laws, regulations and rules when many investors are involved.

To prevent possible dishonest practices by individuals or businesses 100 which have received the financing from the Qualified Investors Club, in one embodiment of the present invention, the Qualified Investors Club can electronically monitor the operations of the individuals or businesses 100 through computer networks. Financial data, auditing results, activities, etc. are electronically collected and recorded in the database of the networked computer system 500 of the Qualified Investors Club so that members 200, 300, 400 of the Qualified Investors Club can review the operational information of the individuals or businesses 100 in real-time or from time to time.

Alternatively, the networked computer system 500 can electronically compare the operational data with the business plan and alert the investors of any discrepancy.

In one embodiment of the present invention, the individuals and businesses 100 answer a series of questions regarding the subjects online through a user interface of the networked computer system 500. The answers are stored in the database of the networked computer system 500 and such information can be used for analyzing and monitoring of the subjects. Furthermore, in another embodiment of the present invention, such information can be provided to the members 200, 300, 400 of the Qualified Investors Club so that they can decide whether they want to re-adjust their investment position in the subjects.

In one embodiment of the present invention, to provide the preferred liquidity protection to its members 200, 300, 400, the Qualified Investors Club permits its members 200, 300, 400 to transfer their sponsorship units of an Angel Fund to other members 200, 300, 400. Since all members 200, 300, 400 of the Qualified Investors Club are qualified investors, such a transfer of sponsorship units of an Angel Fund complies with laws, regulations, and rules. Furthermore, since the Qualified Investors Club is the “same” registered owner of the participation of the business 100 regardless of the transfer of sponsorship units of the Angel Fund, there is no need for the business 100 which has received the financing from the Qualified Investors Club to handle the overhead which would have occurred in the event of ownership changes.

In one embodiment of the present invention, to provide diversification protection to its members 200, 300, 400, the Qualified Investors Club can establish many Angel Funds based on many different business plans from many different individuals and businesses such as the business 100. A member 200, 300, or 400 can easily diversify his/her investment risks by sponsoring different Angel Funds at his/her own preference.

In one embodiment of the present invention, the Qualified Investors Club will electronically provide its members 200, 300, 400 with the up-to-date information of all Angel Funds stored in the database of the networked computer system 500, including the original business plans, modified versions, if any, of the business plans, the current progress of the business plans, the general market conditions, analysts' comments, statements by the individuals or the businesses 100, discussions among all investors, operational information, price of the last transaction, asking price and bidding prices available, etc. With the information provided by the networked computer system 500 through a user interface, members 200, 300, 400 can decide whether they want to re-adjust their investment portfolios from time to time.

In one embodiment of the present invention, a current sponsor of an Angel Fund can transfer his/her sponsorship units to other members 200, 300, 400 by posting his asking price of the sponsorship unit, the number of sponsorship units available for transfer, and the name of the Angel Fund through a user interface of the networked computer system 500. In another embodiment of the present invention, a member 200, 300, or 400 can acquire sponsorship units from the existing sponsors of a particular Angel Fund by posting his/her bidding price of the sponsorship units, the number of units he/she is interested in transfer, and the name of the Angel Fund through a user interface of the networked computer system 500 online. If there is a match between the asking prices and bidding prices of a particular Angel Fund, the computer system 500 of the Qualified Investors Club will complete the transaction electronically. The Qualified Investors Club will collect money from the successful bidders and credit the money to the previous sponsors. The Qualified Investors Club also records the successful bidders as the new sponsors of the Angel Fund in the database of the networked computer 500. Through this process, the sponsorship units of the Angel Fund are effectively transferred.

Some countries have very tight restrictions about the provisions of exchange facilities for securities. In another embodiment of the present invention, the Qualified Investors Club can stay out of the transactions among members. Instead of providing the exchange facilities, the Qualified Investors Club can provide online communication facilities such as social networks, chat room, message center, etc. so that members of the Qualified Investors Club can communicate among one another, share their ideas, and complete their transactions privately. After the completion of a transaction, the Qualified Investors Club will be informed of such a transaction and will record the transfers of the sponsorship units accordingly.

To comply with anti-money laundering, anti-terrorist financing and anti-financial crimes laws, regulations and rules, all transactions and sponsors can be electronically monitored and analyzed by the networked computer system 500 of the Qualified Investors Club so that suspicious activities can be detected and reported to the government agencies.

In the event that the business which has received financing from the Qualified Investors Club issues dividend or other benefits to its shareholders or owners of the subjects, in one embodiment of the present invention, the dividend or benefits issued to the Qualified Investors Club will be further electronically distributed to the then-current sponsors of the particular Angel Fund of the business according to their respective percentage sponsorship of the Angel Fund. In the event that the business which has received financing from the Qualified Investors Club is acquired by another business, in another embodiment of the present invention, the proceeds received by the Qualified Investors Club will be further electronically distributed to the then-current sponsors of the particular Angel Fund of said acquired business according to their respective percentage sponsorship of the Angel Fund.

In the event that the privately-held business which has received financing from the Qualified Investors Club plans to go public, in yet another embodiment of the present invention, the Qualified Investors Club will inform the privately-held business to record the then-current sponsors of the particular Angel Fund of the privately-held business as the shareholders of the business according to their respective percentage sponsorship of the Angel Fund.

In general, all the tangible and intangible rights and obligations received by the Qualified Investors Club from an individual or a business 100 which has received financing from the Qualified Investors Club can be passed on to the then-current sponsors of the associated Angel Fund according to their respective percentage sponsorship of the Angel Fund.

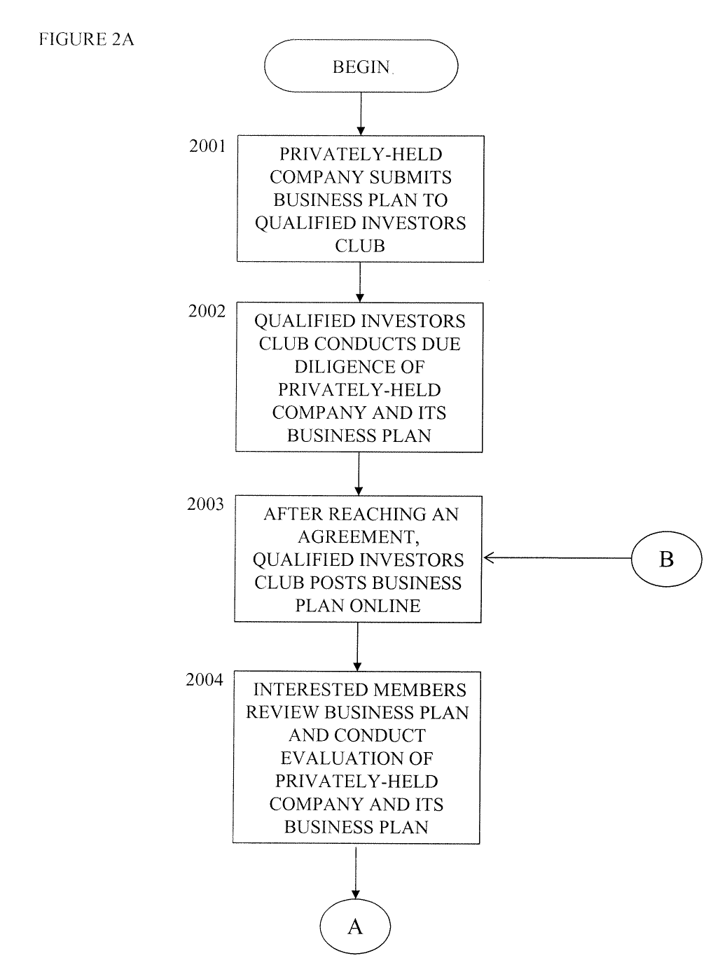

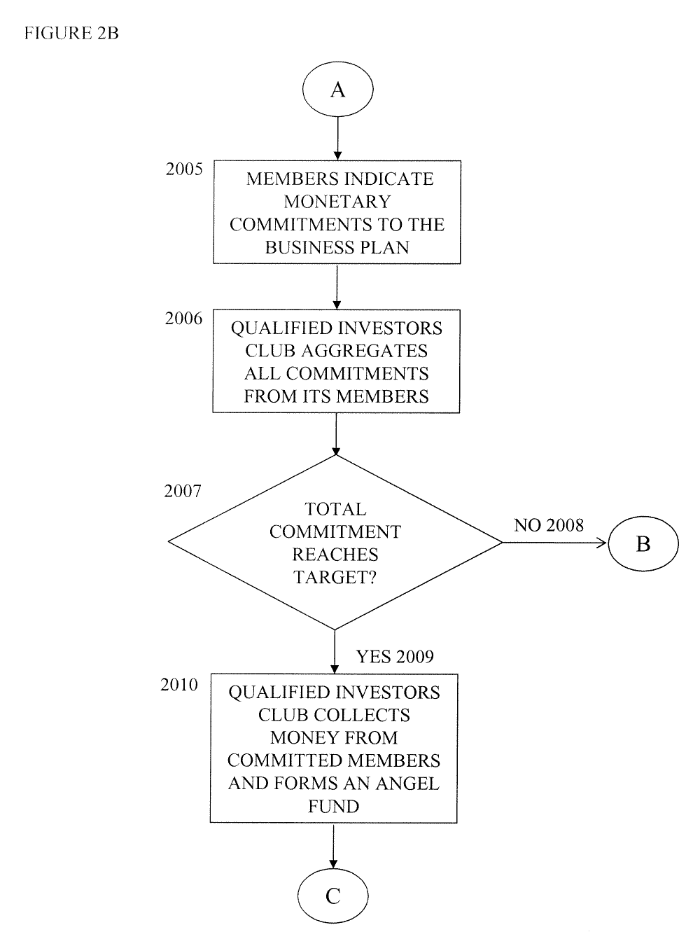

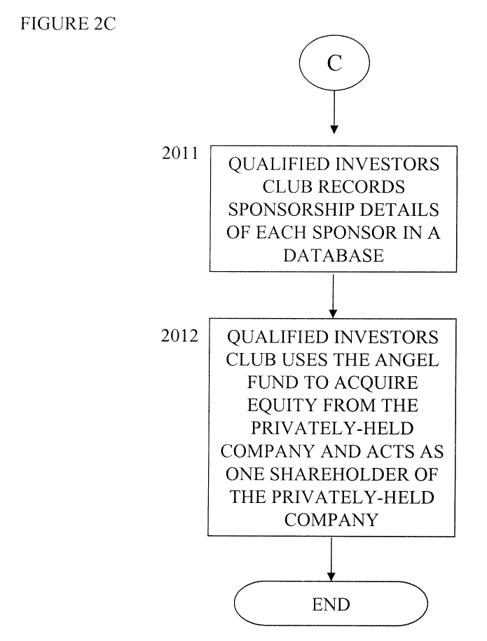

Reference should now be made to the flowchart of FIG. 2 in combination with the network diagram of FIG. 1, which together illustrate how a privately-held company obtains financing through the Automated Private Financing Network (“APFN”).

First (block 2001), a privately-held company 100 submits its business plan to the Qualified Investors Club and answers a series of questions through the user interface of the networked computer system 500 of the Qualified Investors Club and the Internet 600.

Then (block 2002), the networked computer system 500 of the Qualified Investor Club electronically conducts due diligence of the privately-held company 100 and its business plan.

After the privately-held company 100 and its business plan have been approved and the privately-held company 100 has electronically accepted the agreement posted by the networked computer system 500 of the Qualified Investors Club (block 2003), the networked computer system 500 of the Qualified Investors Club electronically posts the background of the privately-held company 100 and its business plan online, for example, as a multimedia presentation over the Internet 600.

After reviewing the business plan and related information through a user interface of the networked computer system 500 (block 2004), Members 200, 300, 400 of the Qualified Investors Club, who are interested in the business plan, will conduct their own evaluations of the privately-held company 100 and its business plan.

As a result of the evaluations (block 2005), interested Members of the Qualified Investors Club will electronically indicate their respective monetary commitments to the business plan of the privately-held company 100 through a user interface of the networked computer system 500.

Then (block 2006), the networked computer system 500 of the Qualified Investors Club aggregates all the commitments from its members to the business plan of the privately-held company 100.

The networked computer system 500 of the Qualified Investors Club compares the total commitment from its members with the fund raising target of the business plan of the privately-held company 100 (decision block 2007).

If the total commitment from the members does not meet the fund raising target of the business plan (NO branch 2008), the Qualified Investors Club may need to electronically reach a revised agreement with the privately-held company 100 and re-start the fund raising process from block 2003.

On the other hand, if the total commitment from the members 200, 300, 400 has met the fund raising target of the business plan (YES branch 2009), the Qualified Investors Club collects the money from the committed members to establish an Angel Fund (block 2010) and each committed member is a sponsor of the Angel Fund.

The networked computer system 500 of the Qualified Investors Club records the sponsorship units of each sponsor (i.e., committed member) in a database which is maintained by the networked computer system 500 of the Qualified Investors Club (block 2011).

The Qualified Investors Club uses the Angel Fund to acquire equity of the privately-held company 100 and becomes one shareholder of the privately-held company 100 (block 2012).

As a result, the privately-held company has obtained its needed financing by adding one new shareholder, the Qualified Investors Club.

To provide its members with the desired liquidity protection, the Qualified Investors Club permits a sponsor to transfer his/her sponsorship units of an Angel Fund to other members.

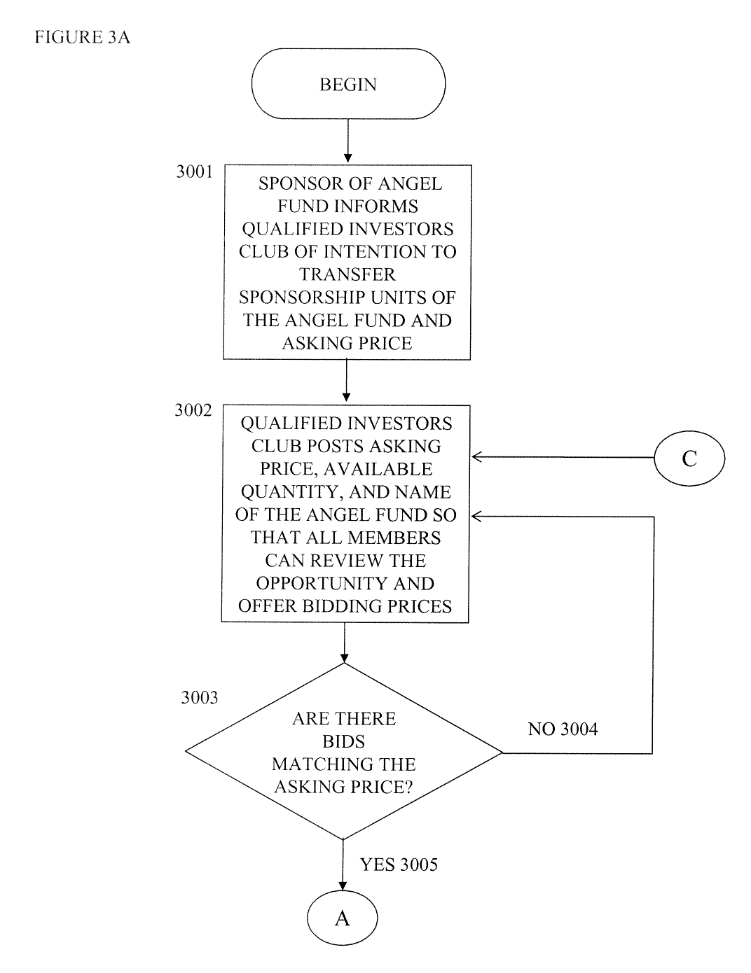

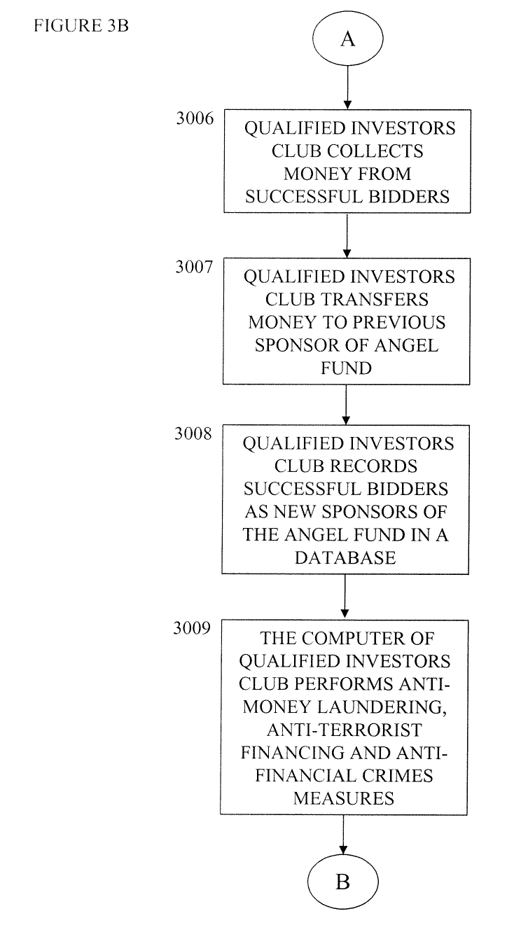

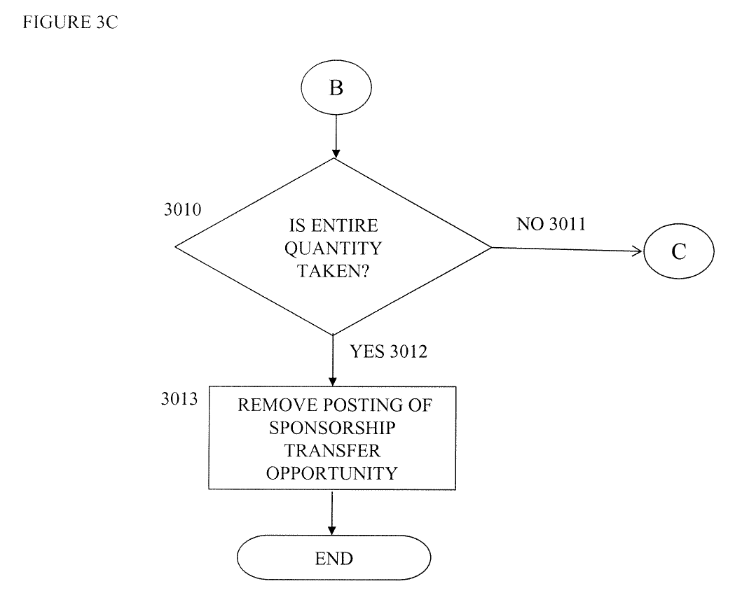

Reference should now be made to the flowchart of FIG. 3 in combination with the system and network diagram of FIG. 1, which together illustrate how a member can have liquidity protection through the Automated Private Financing Network (“APFN”).

First (block 3001), a sponsor of a particular Angel Fund electronically informs the Qualified Investors Club of his/her intention to transfer the sponsorship units of the Angel Fund, asking price of the sponsorship unit and the number of units to be transferred through a user interface of the networked computer system 500 of the Qualified Investors Club.

Then (block 3002), the Qualified Investors Club electronically posts the asking price of the sponsorship unit, the number of sponsorship units available for transfer, and the name of the Angel Fund so that all interested members can review this investment opportunity and offer their bidding prices online through a user interface of the networked computer system 500 of the Qualified Investors Club.

The networked computer system 500 of the Qualified Investors Club electronically monitors if there are bids to match the asking prices (decision block 3003).

If there is no bid to match the asking price (NO branch 3004), the networked computer system 500 of the Qualified Investors Club will repeat the process of posting the asking price which can be modified by the asking sponsor from time to time, the number of units available which can be different from time to time, and the name of the Angel Fund as shown in block 3002 online through the network 600.

If there are bids that match the asking price (YES branch 3005), the networked computer system 500 of the Qualified Investors Club electronically completes the transaction and collects money from the successful bidders (block 3006).

Then (block 3007), the networked computer system 500 of the Qualified Investors Club will electronically transfer the collected money to the previous sponsor who intends to transfer his/her sponsorship units to other members.

After the money transfer (block 3008), the networked computer system 500 of the Qualified Investors Club will record the successful bidders as the new sponsors of the Angel Fund and their respective numbers of sponsorship units in a database maintained by the networked computer system 500 of the Qualified Investors Club.

Furthermore (block 3009), the networked computer system 500 of the Qualified Investors Club electronically performs anti-money laundering, anti-terrorist financing and anti-financial crimes measures according to laws, regulations and rules.

Then (decision block 3010), the networked computer system 500 of the Qualified Investors Club electronically monitors whether all the sponsorship units available from the previous sponsor are taken through bids based on the asking price. If the answer is “No” (NO branch 3011), the Qualified Investors Club will continue electronically posting the asking price, the then-current available quantity, and the name of the Angel Fund in block 3002 online through the network 600. If the answer is “Yes” (YES branch 3012), the networked computer system 500 of the Qualified Investors Club electronically removes the posting for sponsorship transfer opportunity of the Angel Fund (block 3013).

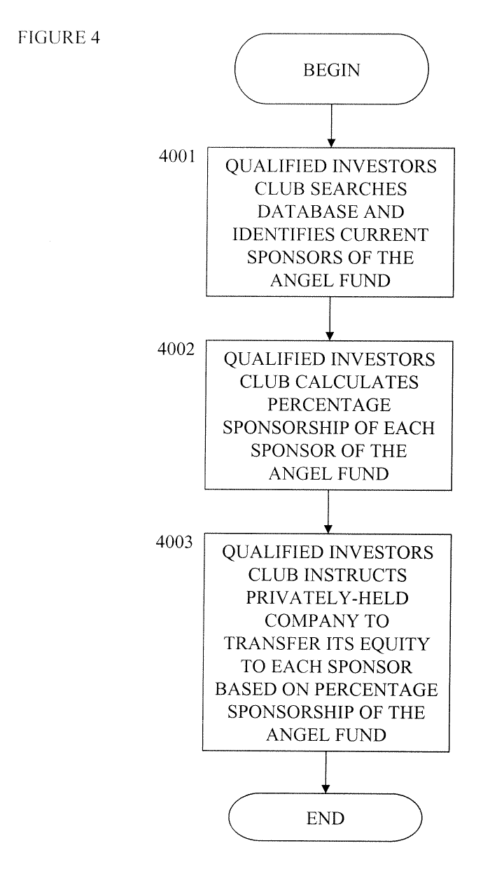

In the event that the privately-held company 100 goes public, the sponsors of the Angel Fund of the privately-held company 100 can realize their financial rewards. Reference should now be made to the flowchart of FIG. 4 in combination with the network diagram of FIG. 1, which together illustrate how a sponsor can realize such a financial reward through the Automated Private Financing Network (“APFN”).

First (block 4001), the networked computer system 500 of the Qualified Investors Club electronically searches its database and identifies the current sponsors of the Angel Fund of the privately-held company 100. Then (block 4002), the networked computer system 500 of the Qualified Investors Club electronically calculates the percentage sponsorship of each then-current sponsor of the Angel Fund. After the percentage sponsorship is calculated (block 4003), the networked computer system 500 of the Qualified Investors Club informs the privately-held company 100 to transfer the equity of the Qualified Investors Club to each of the then-current sponsors of the Angel Fund based on his/her percentage sponsorship of the Angel Fund.

As a result, a sponsor of an Angel Fund can sell his/her equity shares to the public and receive the desired financial reward as a result of sponsorship of the Angel Fund.

Although the present invention and its advantages have been described in detail, it should be understood that various changes, substitutions and alterations can be made herein without departing from the spirit and scope of the invention as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure, processes, machines, manufacture, compositions of matter, means, methods, or steps, presently existing or later to be developed that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

What is claimed is:

1. A networked computer system for enabling investors to adjust investment portfolios in subjects not traded in a public market, the system comprising:
a Qualified Investors Club computer system that receives over a network at least a portion of a business plan regarding participation in a subject, the Qualified Investors Club computer system electronically posting over the network at least the portion of the business plan as an investment opportunity to members of a Qualified Investors Club; and
a database that records the participation in the subject with the Qualified Investors Club as the owner of the participation, each member who invests in an Angel Fund for participation in the subject as a current sponsor of the Angel Fund, each member being associated with a number of sponsorship units based upon an amount of investment in the Angel Fund, the database also recording transfers of sponsorship units of the Angel Fund between members of the Qualified Investors Club.

2. The system of claim 1, further comprising an alerting system for notifying current sponsors of the Angel Fund of rights and obligations resulting from participation in the subject.

3. The system of claim 1 further comprising:
a transfer system that transfers sponsorship units of the Angel Fund between members of the Qualified Investors Club via a computer network.

4. The system of claim 3 wherein a monetary value of each sponsorship unit can differ during each transfer, the monetary value being based on an agreement between a member who is buyer of the sponsorship unit and a member who is a seller of the sponsorship unit.

5. The system of claim 2 wherein the rights and obligations of the current sponsors of the Angel Fund are based on a percentage sponsorship of each sponsor of the Angel Fund.

6. A networked computer system that electronically collects a business plan and operational information of at least one subject, the system comprising:
a database storing the collected business plan and operational information of the subject, the business plan and operational information being available for review online through a network by at least one investor or one potential investor.

7. The system of claim 6, further comprising an alerting system that generates an alert when the collected operational information does not comply with the business plan associated with the subject.

8. The system of claim 6 further comprising:
a reporting system that generates a status report that compares the collected operational information against performance targets of the business plan associated with the subject.

9. The system of claim 1 further comprising:
an online communications system that enables transfer of sponsorship units among members of the Qualified Investors Club.

10. The system of claim 1 further comprising:
an online trading system that electronically enables trading of sponsorship units among members of the Qualified Investors Club.

11. The system of claim 1, further comprising:
a due diligence system which electronically evaluates at least a portion of the business plan.

12. The system of claim 1, further comprising:
a due diligence system which electronically evaluates at least a portion of a background of an owner of the subject.

13. The system of claim 1, further comprising:
a due diligence system which electronically evaluates at least a portion of a background of a member of the Qualified Investors Club.

14. The system of claim 1, further comprising:
a matching system which electronically matches an investment opportunity with at least an interest of a member of the Qualified Investors Club.

15. The system of claim 14, further comprising:
a noticing system which electronically informs at least a member of the matching investment opportunity.

16. The system of claim 1, further comprising:
an anti-money laundering, anti-terrorist financing and/or anti-financial crimes system which electronically monitors a transaction, a member, and/or a subject in compliance with at least a law, a rule, or a regulation.

17. A computerized and networked method to provide investors with liquidity for investments in a plurality of subjects that are not traded in a public market, comprising:
electronically receiving, via a computer network, at least a portion of a business plan regarding participation in a subject;
electronically posting, via the computer network, at least the portion of the business plan as an investment opportunity;
recording in a database each member who invests in an Angel Fund as a current sponsor of the Angel Fund with a number of sponsorship units based upon an amount of investment, the Angel Fund purchasing participation in the subject with the Qualified Investors Club as an owner of the participation;
enabling electronic transfer of sponsorship units of the Angel Fund to other members; and
recording in the database rights and/or obligations resulting from participation in the subject for current sponsors of the Angel Fund.

18. The method of claim 17, further comprising evaluating at least the portion of the business plan.

19. The method of claim 17, further comprising evaluating a portion of the background of an owner of the subject.

20. The method of claim 17, further comprising establishing the Qualified Investors Club as a legal entity and all members as owners of the legal entity.

21. The method of claim 17 further comprising establishing the Angel Fund as an investment project inside the legal entity, each subject of the plurality of subjects being sponsored by different owners.

22. The method of claim 17 further comprising:
facilitating online communications so that members of the Qualified Investors Club can independently communicate among one another and independently conduct transfers of sponsorship units.

23. The method of claim 17 further comprising:
establishing the Angel Fund as a separate legal entity, all sponsors being owners of the separate legal entity, wherein sponsorship units represent ownership units of the separate legal entity.

24. The method of claim 17 further comprising:
conducting at least one anti-money laundering, at least one anti-terrorist financing or at least one anti-financial crimes measure which include comparing members, individuals, businesses, organizations, and titles against at least one blacklist published by at least one government and acting as required by at least one law, regulation and/or rule.

25. The method of claim 17 further comprising:
conducting at least one anti-money laundering, at least one anti-terrorist financing or at least one anti-financial crimes measure by monitoring transactions to detect suspicious activities and acting as required by at least one law, regulation, and/or rule.

26. The method of claim 17 further comprising:
providing online communication facilities so that sponsorship units can be traded privately.

27. A computerized method for facilitating transfer of investments in a subject which is not traded in a public market, comprising:
recording in a database at least a partial ownership acquired in the subject;
electronically distributing sponsorship units of the ownership to a qualified investor; and
electronically transferring the sponsorship units from the qualified investor to another qualified investor.

28. A system for facilitating transfer of investments in a subject that is not traded in a public market, comprising:
a database storing records of at least a partial ownership acquired in the subject; and
a computer system that electronically distributes, via a computer network, sponsorship units of the ownership to a qualified investor, the computer system also enabling electronic transfer of the sponsorship units from the qualified investor to another qualified investor.

29. A system to facilitate financing for a subject that is not traded in a public market, comprising:
a database that records sponsors and their respective sponsorship units of a fund which finances the subject; and
a networked computer system that enables qualified investors to electronically trade sponsorship units through a network.
